(19) United States
(12) Patent Application Publication
(10) Pub. No.: US 2016/0234529 A1
(43) Pub. Date: Aug. 11, 2016

(54) METHOD AND APPARATUS FOR ENTROPY ENCODING AND DECODING

(71) Applicant: SYED SHAKIR IQBAL, New Delhi (IN)

(72) Inventor: SYED SHAKIR IQBAL, New Delhi (IN)

(21) Appl. No.: 14/614,426

(22) Filed: Feb. 5, 2015

(51) Int. Cl. H04N 19/91; H04L 29/06

(52) U.S. Cl. CPC H04N 19/91; H04L 65/607

(57) ABSTRACT

A method for encoding and decoding data includes obtaining sets of pixels from transformed data. A linear index address is obtained from an address of the pixels to obtain a memory transformed address. The memory transformed address is used to obtain a set size of the pixels. Based on the set size and a threshold value, the pixel type is identified from a list of pixel types. Based on the pixel type, a bit stream having a refinement bit is generated.

### BACKGROUND

The present invention relates generally to data compression and decompression of data, and, more particularly, to entropy encoding and decoding.

Data compression plays a vital role in applications such as video conferencing, medical imaging, image data storage, etc. In such applications, storage of image data is very important. In many scenarios, the original amount of data consumes a lot of space and thus efficient data compression is needed, not only to conserve memory, but also to reduce bandwidth.

JPEG (Joint Photographic Experts Group) is a well-known image compression standard that employs a lossy data compression technique based on Discrete Cosine Transform (DCT) in combination with the lossless technique of entropy coding. Thus, entropy encoders are used with almost all image data processing units, including video codecs, to reduce the bit rate/storage requirements by compressing the data. There are multiple techniques for entropy coding. For image transform data like Discrete Cosine Transform (DCT) and Discrete Wavelet Transform (DWT), JPEG usually uses zig-zag coding, while JPEG2000/MPEG4 use set partition coding. Set partition coding is scalable and more efficient than zig-zag coding, but requires a lot of on-chip encoder memory space, much of which is used to store data memory pointers.

That is, in set partition coding, data compression is provided by creating a list of addresses of significant coefficients by relying on set size information. The set size information is retrieved using additional memory banks (for example, First In First Out (FIFO) memory). Further, solutions are also dependent on previous data scanning passes in order to create a list of significant and insignificant pixels for encoding image data, which increases processing time.

Thus, it would be advantageous to have a system with a more memory efficient architecture for a set partition entropy encoder, which can reduce power and improve performance by optimizing the encoding algorithm.

### BRIEF DESCRIPTION OF THE DRAWINGS

The following detailed description of the preferred embodiments of the present invention will be better understood when read in conjunction with the appended drawings. The present invention is illustrated by way of example, and not limited by the accompanying FIG.s, in which like references indicate similar elements.

FIG. 1 is a schematic block diagram of a system for encoding and decoding image data;

FIG. 2 is a schematic block diagram of an apparatus for encoding image data in accordance with an embodiment of the present invention;

FIG. 3 illustrates an example of partitioning of a set in a data encoding apparatus in accordance with an embodiment of the present invention;

FIG. 4 is a schematic block diagram of an address control and generation unit of the encoder of FIG. 2 in accordance with an embodiment of the present invention;

FIG. 5 illustrates a priority encoder of an address control and generation unit in accordance with an embodiment of the present invention;

FIG. 6 illustrates a pixel tester of the encoder of FIG. 2 in accordance with an embodiment of the present invention;

FIG. 7 illustrates mixing of scanning passes in an encoding apparatus in accordance with an embodiment of the present invention;

FIG. 8 is a schematic block diagram of an apparatus for decoding encoded data in accordance with an embodiment of the present invention;

FIG. 9 illustrates a decoder pixel tester of the decoder of FIG. 8 in accordance with an embodiment of the present invention;

FIG. 10 is a flow chart of a method for encoding data in accordance with an embodiment of the present invention;

FIGS. 11A, 11B and 11C illustrate a flow chart of a method for encoding data for generation of bit stream in a single pass in accordance with an embodiment of the present invention;

FIG. 12 illustrates presumption of octave band partitioning in a method of encoding data in accordance with an embodiment of the present invention;

FIGS. 13A, 13B and 13C illustrate a flow chart of a method for encoding bits in a bit stream in sequential order, in accordance with an embodiment of the present invention;

FIG. 14 is a flow chart of a method for decoding data in accordance with an embodiment of the present invention;

FIGS. 15A and 15B illustrate a flow chart of a method for arranging bits in a bit stream in a single pass in a decoding method, in accordance with an embodiment of the present invention; and

FIGS. 16A, 16B and 16C illustrate a flow chart of a method for decoding encoded bits in a bit stream in sequential order, in accordance with an embodiment of the present invention.

### DETAILED DESCRIPTION OF THE INVENTION

The detailed description of the appended drawings is intended as a description of the currently preferred embodiments of the present invention, and is not intended to represent the only form in which the present invention may be practiced. It is to be understood that the same or equivalent functions may be accomplished by different embodiments that are intended to be encompassed within the spirit and scope of the present invention.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

While the invention is described for a system and method for encoding and decoding image data that provide compression and decompression of image data in a computing environment, the invention may be implemented in any number of different computing systems, environments, and/or configurations. The embodiments are described in the context of the following exemplary system.

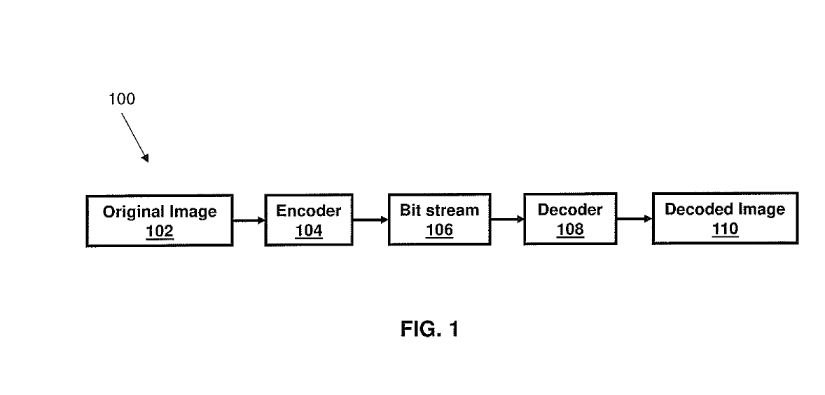

Referring to FIG. 1, a block diagram of a system 100 for compression and decompression of data (for example, image data) is shown. A first block 102 receives data, such as image data, in a predetermined format. The data is transformed by executing a data compression technique, e.g., JPEG by an entropy encoder 104. The entropy encoder 104 generates a bit stream to further compress the transformed data. The bit stream, shown at block 106, represents a minimum number of bits required to represent the original data. The bit stream is passed from block 106 to a decoder 108. The decoder 108 decodes the bit stream to generate a decoded image, shown at block 110.

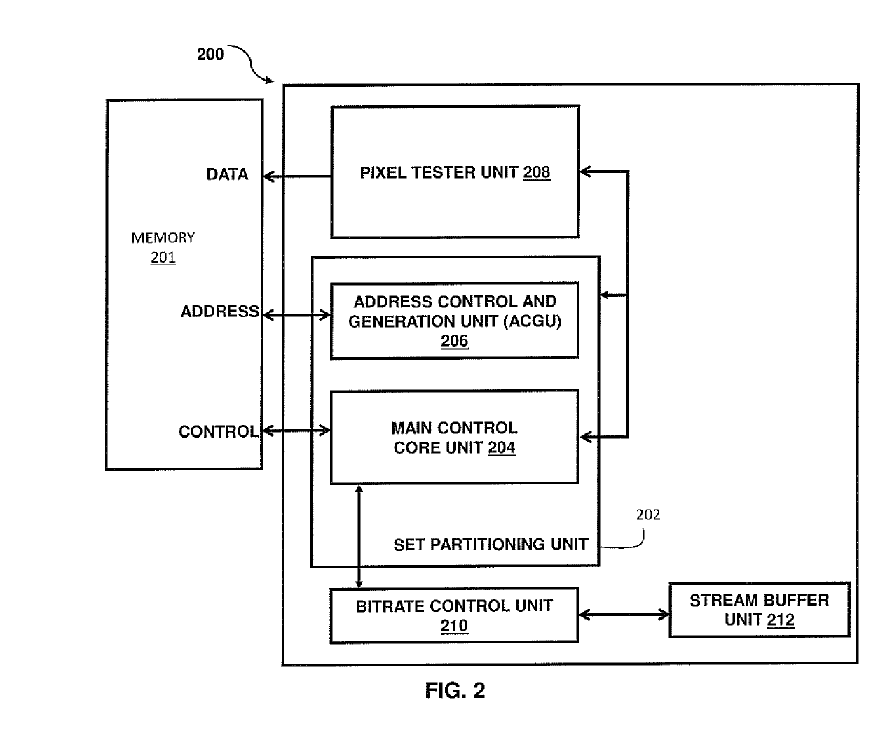

Referring to FIG. 2, a block diagram of an apparatus 200 for encoding data in accordance with an embodiment of the present invention is shown. The apparatus 200 may be implemented with one or more data processors, such as a Freescale i.MX6 family multimedia processor, available from Freescale Semiconductor, Inc. of Austin, Tex. The apparatus 200 includes a set partitioning unit 202. The set partitioning unit 202 comprises a main control core unit 204 and an address control and generation unit (ACGU) 206. The apparatus 200 further comprises a pixel tester unit 208, a bitrate control unit 210 and a stream buffer unit 212. The apparatus 200 may be implemented as an entropy encoder with one or more image data processing units (including video codecs) for additional compression of data. The data may include image data and/or video data. In one example, the data comprises image data having a size of 512×512 pixels.

The main control core unit 204 controls operation of the one or more data processing units in the apparatus 200, and is configured to synchronize these data processing units. The main control core unit 204 controls the amount of information fetched or retrieved from a memory 201, which is coupled to the apparatus 200. The memory 201 is used to store transformed data. The transformed data is a transformed form of the original data after a first level of data compression.

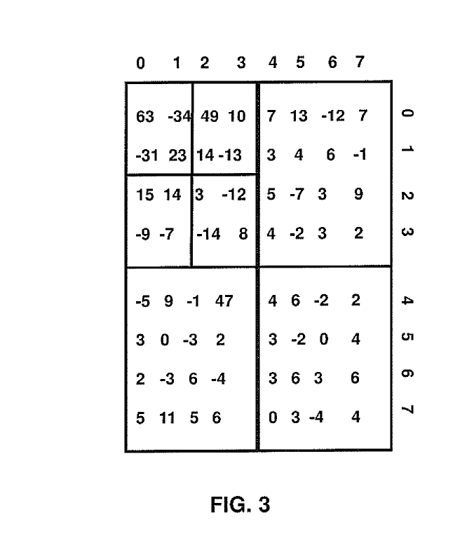

The apparatus 200 may include a receiver unit (not shown in FIG. 2) that receives the transformed data from the memory 201. The transformed data may be referred to herein as memory data stored in the memory 201 since the transformed data is fetched from the memory 201. The set partitioning unit 202 partitions the transformed data into a plurality of sets. In an example, the plurality of sets includes four sets (4S). The plurality of sets provide information about significant coefficients of one or more pixels associated with the plurality of sets, which may be identified by analyzing the pixel bits. In an example, FIG. 3 shows the set partitioning hierarchy for a transformed data array, which is the input to the encoder 200. The transformed data comprises an 8×8 square array that can be further divided into four subsets for each quarter of size 4×4 as shown by the array borders. Each of these 4×4 sets can further be divided into subsets of size 2×2. Thus each of these 4×4 and 2×2 pixel groups are the representation of sets that are to be encoded.

In accordance with an embodiment, the ACGU 206 is configured to determine addresses of one or more pixels of the plurality of sets of the transformed data stored in the memory 201. The pixel address is determined in order to obtain a set size of each set from the plurality of sets. For example, the least significant value 1 of the pixel may decide the set size.

The main control core unit 204 controls the fetching of data from the memory 201 by controlling the ACGU 206 and the ACGU 206 only accesses the memory data to determine the pixel address. After obtaining the pixel address of the one or more pixels, the ACGU 206 exchanges set size (current set size) with the pixel tester unit 208. The ACGU 206 also checks a next pixel address, and a decoded address. The next address corresponds to the memory address of the next transformed coefficient/pixel that the encoder 200 is supposed to fetch while the decoded address is memory address for the last element in a given set that is being checked. For example, referring to FIG. 3 if the encoder 200 is checking the set element {−34} in the 2×2 set (top left) having elements {63,−34,−31, 23} with address locations given as {0,1,2,3} respectively, then the next address will be 2, which corresponds to the address of the element after {−34} i.e., {−31}. The decoded address will be the address of the last element in the set, which is 3 for element {23}.

The apparatus 200 further comprises the bit rate control unit 210 and the stream buffer unit 212. The bit rate control unit 210 controls a data encoding rate while generating an output bit stream through the main control core unit 204. The stream buffer unit 212 checks if the budget of the output is fine or not. For example, if the apparatus 200 must encode the image data into 100 bits, the stream buffer unit 212 checks that once 100 bits have been generated by the apparatus 200, the apparatus 200 will truncate and stop the generation of the bit stream and pass the encoded data to a decoder.

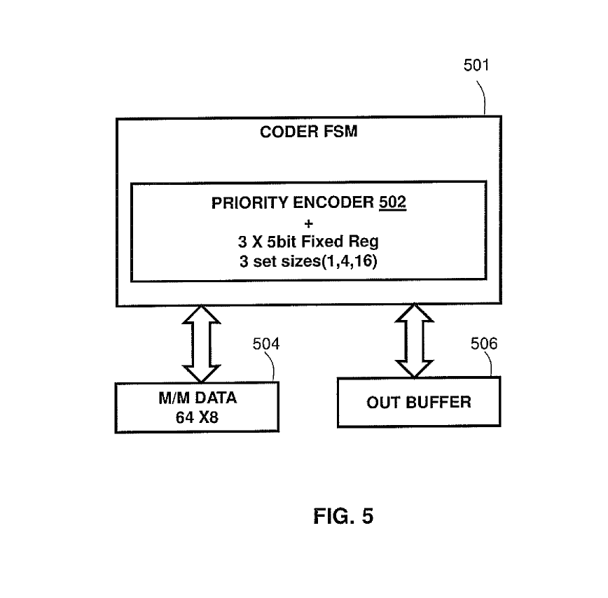

Referring to FIG. 5, in an embodiment, the ACGU 206 includes a coder finite state machine (FSM) 501, which includes a priority encoder 502. The AGCU 206 decodes the next address from the current address with the priority encoder 502, and some additional logic such as shift registers based on core control signals from the main control core unit 204. The shift registers may a include 3×5 bit fixed register for fetching the address from 64×8 memory data 504 to fill an output buffer 506.

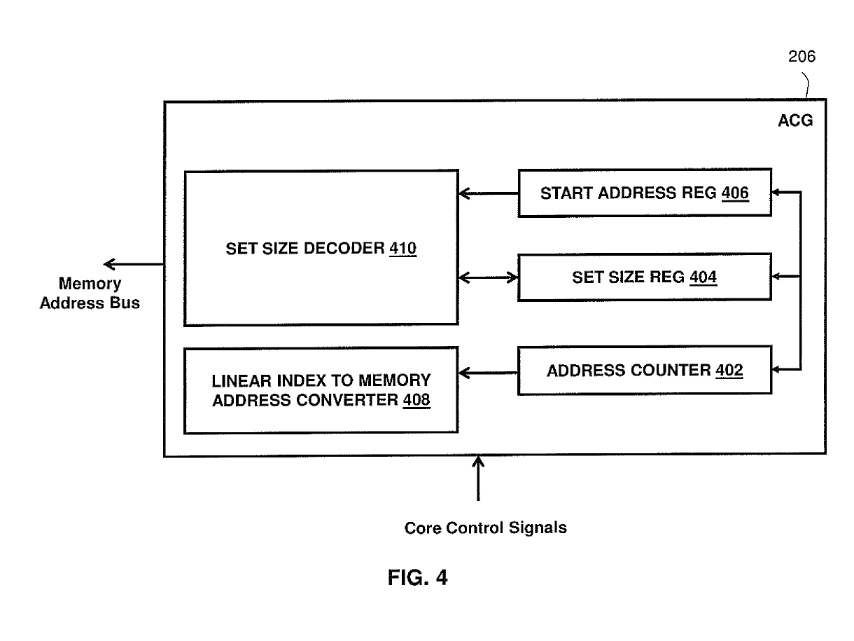

Referring to FIG. 4, the ACGU 206 also comprises an address counter 402, a set size register 404, a start address register 406, a linear index to memory address converter 408 and a set size decoder 410. The set size register 404 and the start address register 406 may comprise shift registers.

The address of a pixel is retrieved by the ACGU 206 using a linear indexing or a column-row based interlacing. The address comprises a row memory address and a column memory address. The linear index address priority decoding scheme of the present invention removes a requirement of a temporary memory (for example a FIFO) as the set size may be directly determined from the address of the pixel.

In accordance with an embodiment, table 1 shows address of the pixel and the set size determined by the ACGU 206 from the pixel address.

TABLE 1

| | | Extracted | Old | New | | |
|---|---|---|---|---|---|---|
| Linear | Address | priority | Set | Set | ACGU | |
| Address | bits | address | size | size | Action | Comment |
| 16 | “01000” | 1000 | 16 | 16 | Decode | The first size |
| | | | | | | of a set |
| | | | | | | starting at 16 |
| | | | | | | will always be |
| | | | | | | 16 and may be |
| | | | | | | only changed |
| | | | | | | to 4 or lower |
| | | | | | | by Quad tree |
| | | | | | | partition |
| 48 | “11000” | 1000 | 16 | 16 | Decode | The first size |
| | | | | | | of a set |
| | | | | | | starting at 48 |
| | | | | | | will always be |
| | | | | | | 16 and may be |
| | | | | | | only changed |
| | | | | | | to 4 or lower |
| | | | | | | by Quad tree |
| | | | | | | partition |
| 49 | “11001” | 1 | 4 | 1 | Divide | The size of a |
| | | | | | by 4 | set starting |
| | | | | | | at 49 should |
| | | | | | | be 1 as this |
| | | | | | | set must have |
| | | | | | | already been |
| | | | | | | Quad |
| | | | | | | partitioned |
| 37 | “10101” | 1 | 4 | 1 | Divide | The size of a |
| | | | | | by 4 | set starting |
| | | | | | | at 37 should |
| | | | | | | be 1 as this |
| | | | | | | set must have |
| | | | | | | already been |
| | | | | | | Quad |
| | | | | | | partitioned |
| 12 | “01100” | 100 | 4 | 4 | Decode | The size of a |
| | | | | | | set starting |
| | | | | | | at 12 should |
| | | | | | | be 4 as this |
| | | | | | | set must have |
| | | | | | | already been |
| | | | | | | Quad |
| | | | | | | partitioned |

Referring to FIG. 4, the set size decoder 410 is configured to either divide the old set size of each of the sets of the plurality of sets by 4 or predict/decode the new set size as per the lookup table (shown in Table 1). The set size decoder 410 determines whether the current size of the set has to be checked for a new address or whether the set size is to be segmented into 4 arms. The linear index to memory address converter 408 converts the interlaced address column and row address into the memory address in order to determine the set size from the memory address.

The start address register 406 tracks the current address of the set from which the new address is to be decoded and the set size register 404 tracks the set size. For example, if the ACGU 206 is processing a set of 4 pixels, the address counter 402 starts from the start address count and continues counting until the set size stored in the register 404 is reached. By doing so the address counter 402 is providing the address of two registers i.e., the set size register 404 and the start address register 406. The address counter 402 is providing the address of 4 pixels in that set in a sequential order and accordingly the data will be fetched from the memory 201 and transmitted to the pixel tester unit 208.

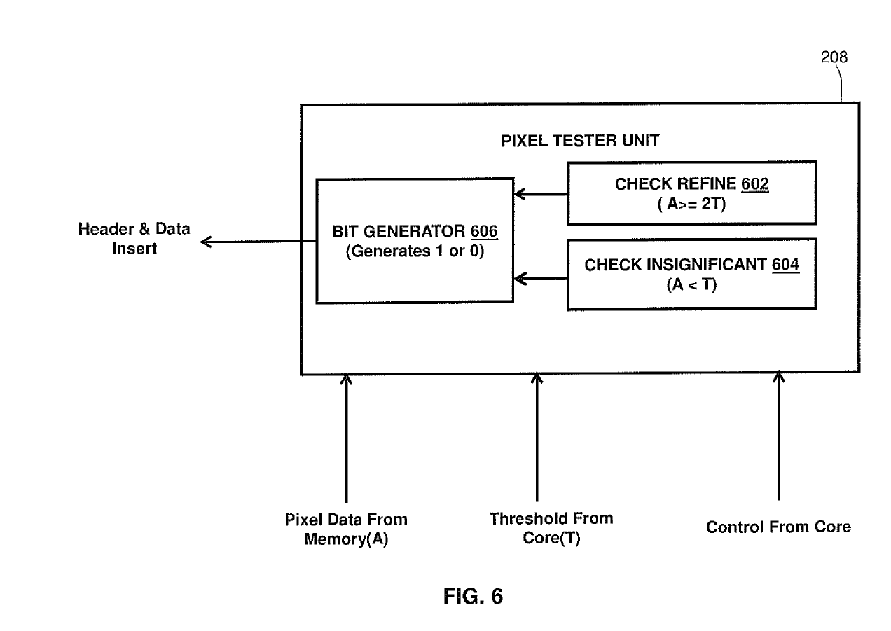

Referring to FIG. 6, the pixel tester unit 208 scans each set of the plurality of sets in accordance with the set size to determine a pixel type based on a list of pixel type. The list of pixel type comprises a refinement pixel, an insignificant pixel and a significant pixel. The pixel tester unit 208 checks the pixel type based on a threshold value by performing a plurality of scanning passes. The scanning passes comprise a refinement pass and a sorting pass. The pixel tester unit 208 merges the refinement pass and the sorting pass while scanning each set of the plurality of sets.

In an example, the threshold value may be the value of the highest bit in the pixel. The pixel tester unit 208 reads the set size and the threshold value (provided by the main controller core unit 204), and checks the pixel type as at least one of the refinement pixel, the significant pixel and the insignificant pixel. The pixel tester unit 208 provides a signal, based on the pixel and generates a 0 or 1 bit based on the control signal from the main controller core unit 204. If the pixel tester unit 208 determines that the pixel is a significant pixel it generates a two bit pattern which is either “11” or “10”. The first bit in this pattern is the pixel's bit value corresponding to the current bit plane or pass (which will always be 1 for a significant pixel by the nature of the test itself) being encoded while the latter is the corresponding sign bit (can be 0 for positive and 1 for negative). For an insignificant pixel, the pixel tester unit 208 only sends a single bit pattern of 0. For a refinement pixel, a single bit pattern (can either be 0 or 1) is generated which corresponds to the current bit plane value of the pixel. For example, if the encoder 200 is checking the 4th bit plane, then for a significant pixel it will send the 4th bit value of the pixel along with its sign bit, while for a refinement pixel, only the 4th bit value is sent. For an insignificant pixel the pattern 0 is fixed. The generated signal 0 or 1 goes into the header and data insert logic of the stream buffer unit 212 and then goes to the main control core unit 204 for generating the bit stream.

In one embodiment, the pixel tester unit 208 comprises a check refine block 602, a check insignificant block 604 and a bit generator 606 for generating the signal 0 or 1. The check refine block 602 checks whether the pixel is a refinement pixel based on the threshold value, while the check insignificant block 604 checks if the pixel is an insignificant pixel, also based on the threshold value.

The threshold value for a refinement pixel, an insignificant pixel and a significant pixel are defined below:
If a pixel value in the set ≧2ⁿ⁺¹ the pixel is a refinement pixel, where n is the value of the most significant pixel;
If a pixel value in the set ≧2ⁿ && <2ⁿ⁺¹ the pixel is a significant pixel;
If the pixel value in the set <2ⁿ the pixel is an insignificant pixel.

The pixel tester unit 208 determines the pixel type as one of a refinement pixel, an insignificant pixel and a significant pixel, and based on the determined pixel type, the bit generator 606 generates the signal 0 or 1 and provides this signal to the stream buffer unit 212, and the main control core unit 204 generates a bit stream in accordance with the signal. In one embodiment, the bits in the bit stream are arranged in a random order. The random order may include refinement bits in the middle of the significant bits. The bit stream is generated, based on the signal from the pixel tester unit 208, in a single pass, i.e. based on merging of the refinement pass and the sorting pass.

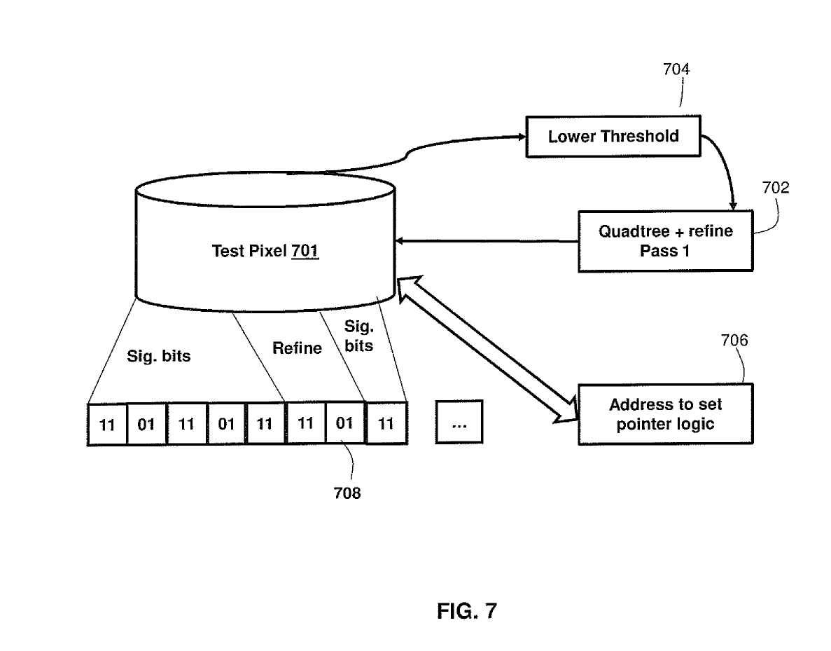

Referring to FIG. 7, an example of bit stream generation in accordance with an embodiment of the invention is shown. Quad tree (sorting) and refinement passes (which are understood by those of skill in the art) are merged and performed on a test pixel 701, at block 702 (conventionally, the quad tree sorting and refinement pass are separate steps) for a lower threshold value, as shown in block 704. The pixel address is retrieved for obtaining the set size by implementing address to set pointer logic at block 706 (linear index to memory converter as discussed for ACGU 206). Accordingly, based on pixel type, the significant bits and the refinement bits are arranged in parallel in the bit stream as shown at 708. That is, the significant bits and the refinement bits are determined in the same pass and merged in the bit stream. This is different from conventional systems, where the significant bits are arranged first, followed by the refinement bits.

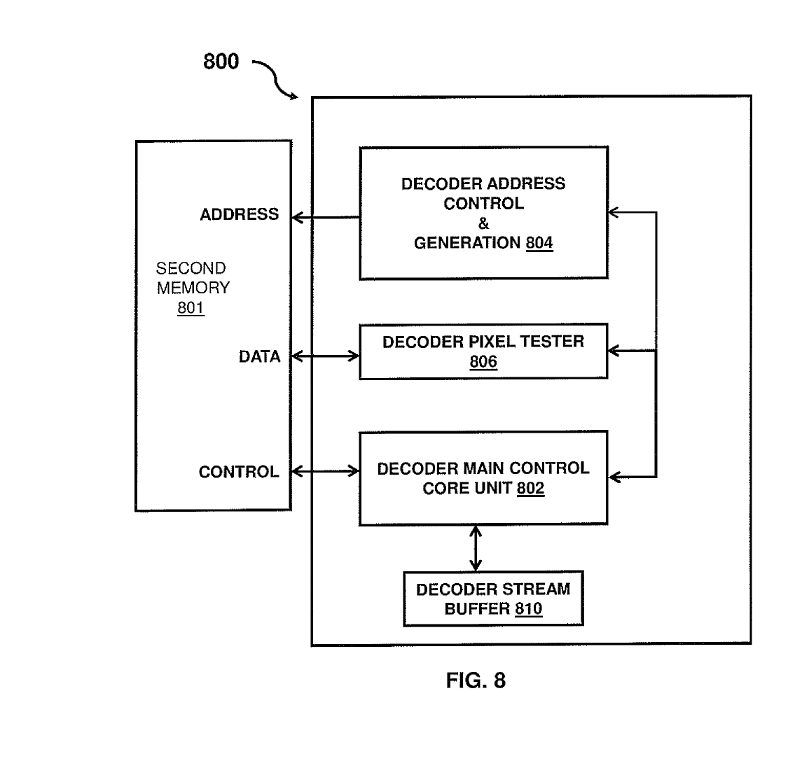

Referring to FIG. 8, a decoder 800 in accordance with an embodiment of the present invention is shown. The encoded data that is decoded by the decoder may include image data and video data. The decoder 800 comprises one or more data processing units (i.e., hardware units), which include a decoder main control core unit 802, a decoder Address Control and Generation unit (ACGU) 804, a decoder pixel tester unit 806, and a decoder stream buffer unit 810.

The decoder main control core unit 802 collects a plurality of bits of a bit stream of the encoded data from a second memory 801. The encoded data may be encoded by the apparatus 200 (an entropy encoder) and stored in the second memory 801.

The decoder ACGU 804 specifies a read address to read the encoded data from the second memory 801, with the encoded data being passed to the decoder pixel tester unit 806.

The decoder pixel tester unit 806 identifies a pixel type of the plurality of bits in the encoded data using a list of pixel types. The pixel type is identified based on a threshold value. The pixel type comprises a refinement pixel, a significant pixel, and an insignificant pixel.

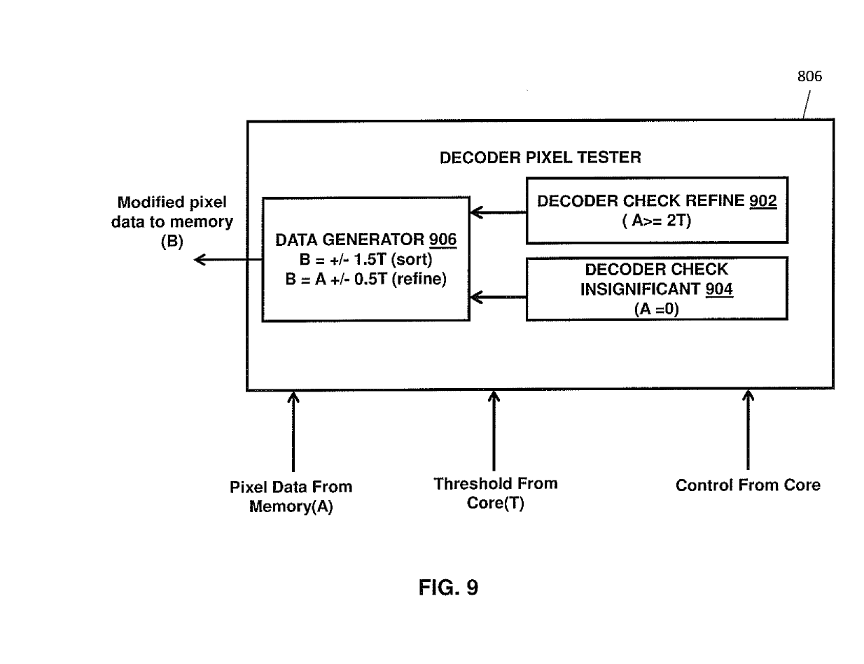

Referring to FIG. 9, a schematic block diagram of the decoder pixel tester unit 806 is shown. The decoder pixel tester unit 806 performs a plurality of scanning passes in combination over the pixels in the bit stream. The decoder pixel tester unit 806 receives pixel data from a memory (A) (i.e., the second memory 801), and threshold value and control signals from the decoder main control core unit 802. The plurality of scanning passes comprises a refinement pass and a sorting pass. The pixel type is identified based on the threshold value. The decoder pixel tester unit 806 comprises a decoder check refine block 902 and a decoder check insignificant block 904, and a data generator 906 for generating modified pixel data. The check refine block 902 checks if the pixel type is a refinement pixel based on the threshold value, while the check insignificant block 904 checks if the pixel type is an insignificant pixel.

For the check refine block, the pixel is determined to be a refinement pixel (refinement bit) when A>=2T, where T is the decimal equivalent threshold value and A is the pixel data received from the second memory 801.

For the check insignificant block 904, the pixel is determined to be an insignificant pixel when A=0.

The data generator block 906 modifies the pixel value based on the pixel type identified by the check refine block 902 and the check insignificant block 904, and generates the modified pixel data for the refinement pixel type and the insignificant pixel type. For the significant pixel, the modified pixel data (B)=+/−1.5T, and for the refinement pixel, the modified data (B)=A+/−0.5 T.

The data generator unit 906 transmits the modified data to the decoder main control core unit 802. The decoder main control core unit 802 writes the modified pixel data to the second memory 801 as decoded data. The decoded data may include a compressed image or an uncompressed image.

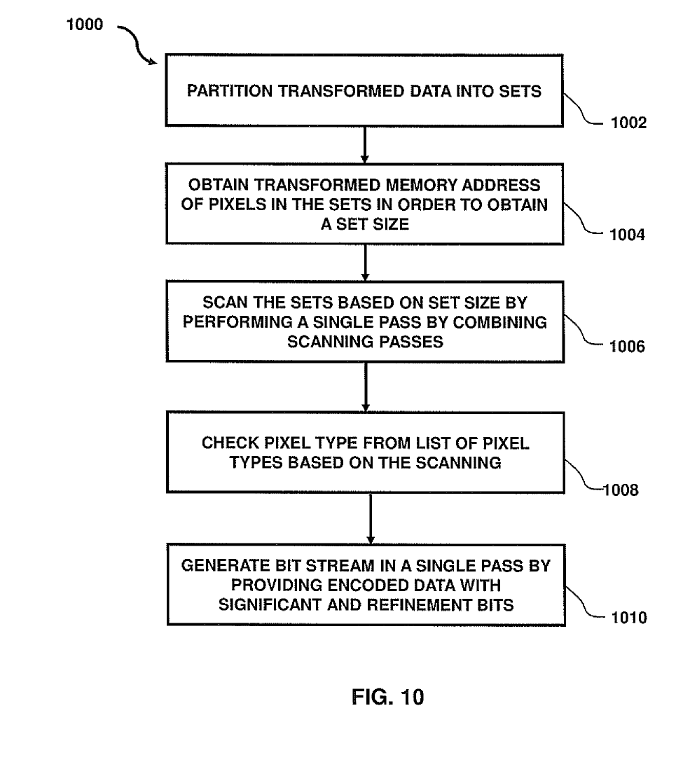

Referring now to FIG. 10, a method 1000 for encoding data in a wavelet based entropy encoder is shown, in accordance with an embodiment of the present invention. The encoding method 1000 may be performed by the encoding apparatus 200 described above.

At step 1002, transformed data is partitioned into a plurality of sets. The set partitioning is performed by entropy codecs using linear indexing or column-row address bit interlacing to convert 2D data into a 1D array. Linear indexing may be used to determine address and set size for square images and rectangular images. An important property of linear indexing is that the new address formed using interlaced bits can predict the associated set size by modifying the coding algorithm (the least significant 1 decides the set size). This addressing scheme allows for the requirement of LIB/LIS to be removed because the set size is directly extracted from the pixel address itself rather than a FIFO memory. For example, consider address 37 (100101-Binary). The address 100101 is an interleaved 2D address with row 4 (100) and column 3 (011). The use of linear indexing avoids a requirement of temporary memory (such as FIFO) for obtaining the set size, as the method obtains set size from the pixel address.

At step 1004, a transformed memory address of one or more pixels in the plurality of sets is obtained in order to obtain a set size. The transformed memory address is obtained from a current address of the one or more pixels retrieved from the memory 201. The transformed memory address is used to decode a next address for the one or more pixels. In one embodiment, the set partitioning unit 204 partitions the set into a plurality of sets and the ACGU 204 retrieves the current address for obtaining the set size.

At step 1006, the transformed data is scanned in a single pass, although the single pass includes multiple scanning passes. That is, the single pass may comprise a plurality of scanning passes, which include a sorting pass and a refinement pass.

At step 1008, a type of pixel of one or more pixels in the set is identified based on the scanning step 1006. In one embodiment, the pixel type is identified by the pixel tester unit 208.

At step 1010, a bit stream of encoded data is generated by arranging in parallel the type of pixel from the list of pixel types. In one embodiment, the bit stream is generated by the main control core unit 204.

Table 2 shows an example of the bits generated by the encoding method 1000, where R indicates a refinement bit, 1 indicates a significant set, 1− indicates a significant coefficient of negative sign bit value, 1+ indicates a significant coefficient of positive sign, and 0 indicates insignificant sets or coefficients.

TABLE 2

| | | | | | | | | | | | | |
|---|---|---|---|---|---|---|---|---|---|---|---|---|
| R | R | 1 | 1− | 1+ | R | 0 | 0 | 0 | 0 | R | 0 | 0 |

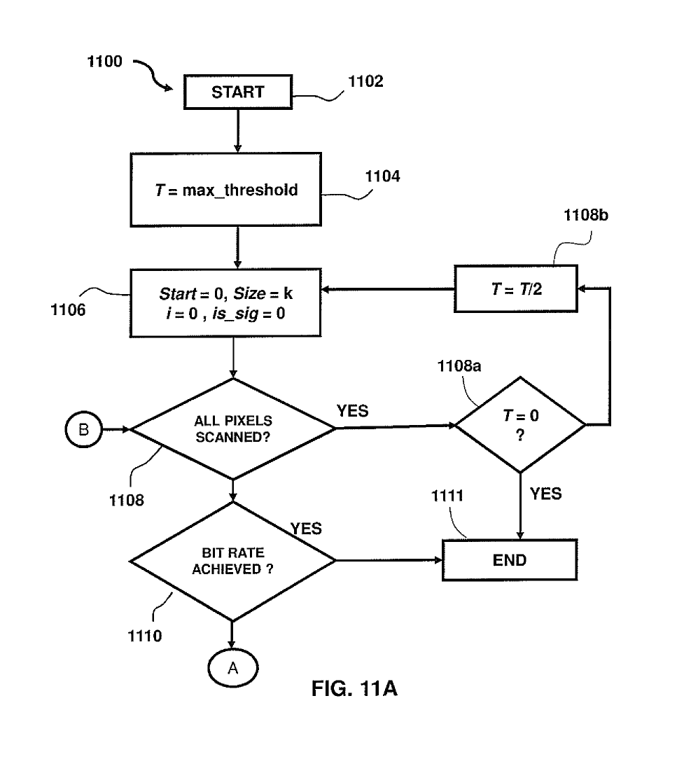

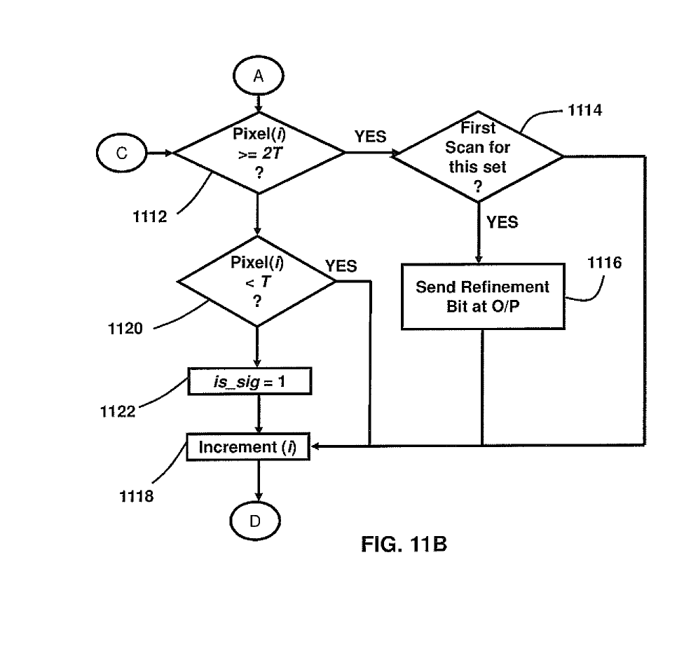

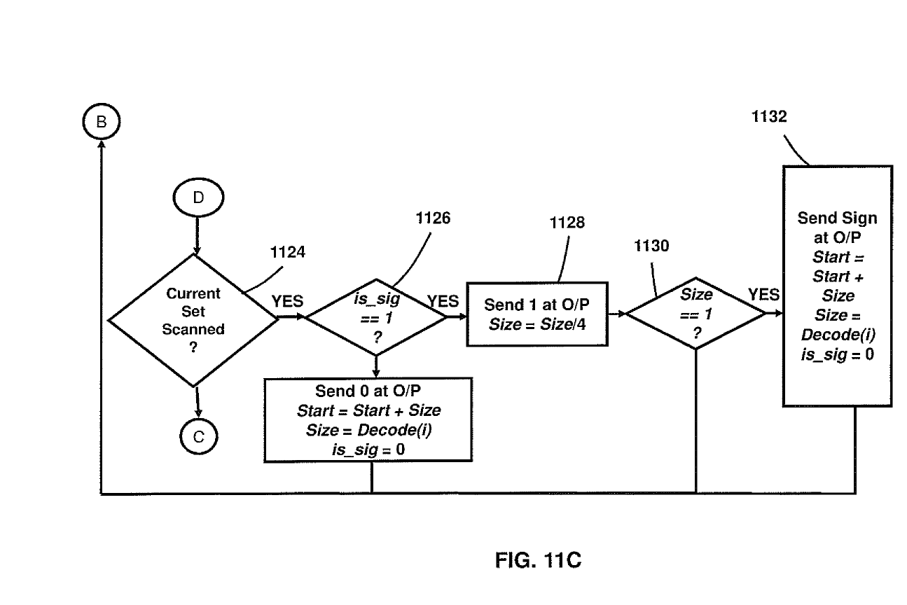

Referring to FIGS. 11A-11C, a more detailed method 1100 for encoding data is shown. The method 1100 provides scanning the plurality of sets to check a type of pixel from a list of pixel types based on a threshold value by performing a plurality of scanning passes. The scanning passes comprise a sorting pass and a refinement pass. The method 1100 merges the sorting pass and the refinement pass. The scanning is performed in accordance with the set size as obtained by the ACGU 206.

The method 1100 starts encoding the data at step 1102. At step 1104, the method 1100 checks for one or more threshold values for checking a pixel type from a list of pixel types. A maximum threshold value may include a value of a most significant bit. For example, if the most significant bit value in the data set of transformed data is 7, then the threshold value is 2⁷.

At step 1106, the method sets one or more variables for encoding the data. In one embodiment, there are four variables, comprising start (value being stored in start register), size (set size) controllable by the user, i iteration for each pass (from address counter 402), and is_sig signal from the pixel tester unit 208. The variables are set or initialized as, start=0), size=k, i=0, and is_sig=0.

At step 1108, the method 1100 checks if the one or more pixels in the set have been scanned or not by checking if the value of i is equal to an end data (end image size) or not. If all of the pixels have been scanned, the method 1100 proceeds to step 1108a to test if the threshold value T equals zero. If the threshold value T equals zero, then the method stops (step 1111). If T is not equal to zero, then the method 1100 proceeds to step 1108b, where T is set to T/2 and then step 1106 is repeated. If all of the pixels have not been scanned (step 1108), the method 1100 moves to the next pass, i.e., the method 1100 checks if the desired pixel rate has been achieved or not at step 1110. In this manner, the method 1100 maintains a count of the number of bits to determine if the encoding should be continued or terminated. The method 1100 stops encoding, step 1111, if the desired bit rate has been achieved.

Referring to FIG. 11B, if the method 1100 continues the encoding from step 1110 because the bit rate has not been achieved, then the method 1100 performs a pixel test of the first pixel, i.e., the pixel denoted by i (steps 1112 and 1114). For example, if there is a set of 16×16 pixels, the method will either scan this set once or twice as per conditions met in steps 1126, 1128 and 1130. Step 1126 executes a single scan while steps 1128 and 1130 scan the set twice, i.e., first scanning the block 16×16, then dividing the block into 4 segments of size 4×4 each and scanning them once again.

The method 1100 checks the pixel with the threshold value for the refinement pixel. If the pixel is a refinement pixel (step 1112), the method 1100 checks if the scan is a first scan for the set (step 1114). If the scan is the first scan, the method 1100 sends the refinement bit at the output (step 1116). After the refinement bit has been sent to the output, the method increments (i) at step 1118. The method 1100 checks if the pixel <T (step 1120). If not the method sets is_sig=1 (step 1122).

Referring now to FIG. 11C, the method 1100 again checks if the current set has been scanned or not (step 1124) and if not, the method loops back to step 1112. If the current set has been scanned, then at step 1126, the method 1100 checks if is_sig=1. If is_sig=1, the method 1100 sends 1 to the output and sets the size=size/4 (step 1128). If is_sig is not equal to 1, the method 1100 sends 0 to the output (step 1127) and then loops back to step 1108. After step 1128, at step 1130, the method 1100 checks if the size=1, and if not, looks back to step 1106; and if size=1, the step 1132 is performed, where the method 1100 sends 1 followed by a sign bit to the output for generating the bit stream.

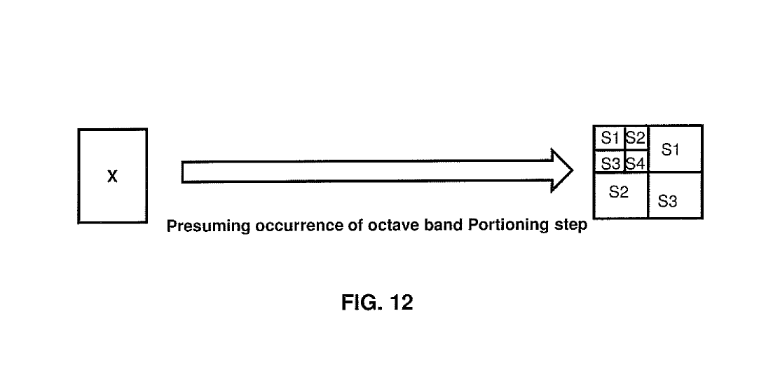

Referring to FIG. 12, the method 1000 (FIG. 10) considers a condition of occurrence of an octave band splitting, and the method 1000 avoids separately performing the octave band splitting. The consideration of the condition may result in a redundancy in set splitting. The redundancy in set splitting avoids a dependency on previous passes for encoding the image. The methods 1000 and 1100 are defined to follow an order from top to bottom while scanning the image. The method 1000 sends three “0” bits at a time.

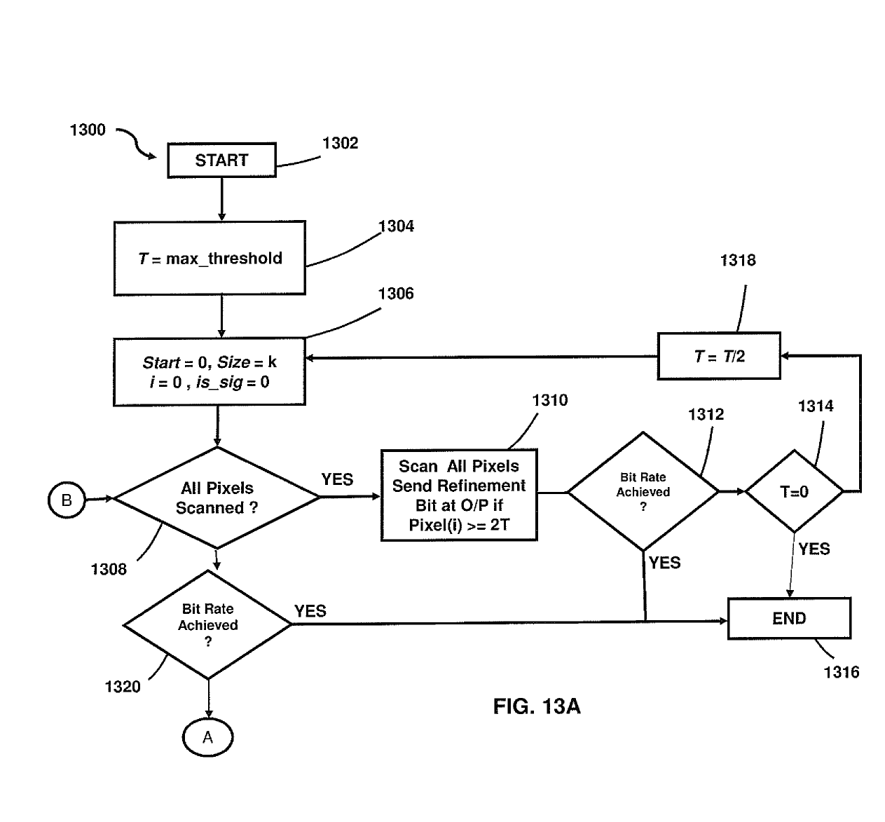

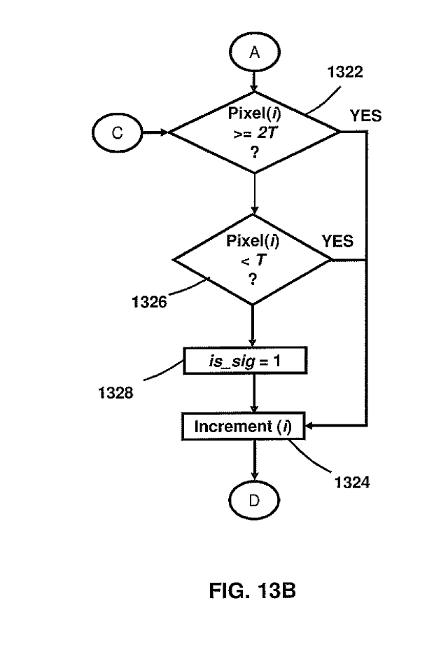

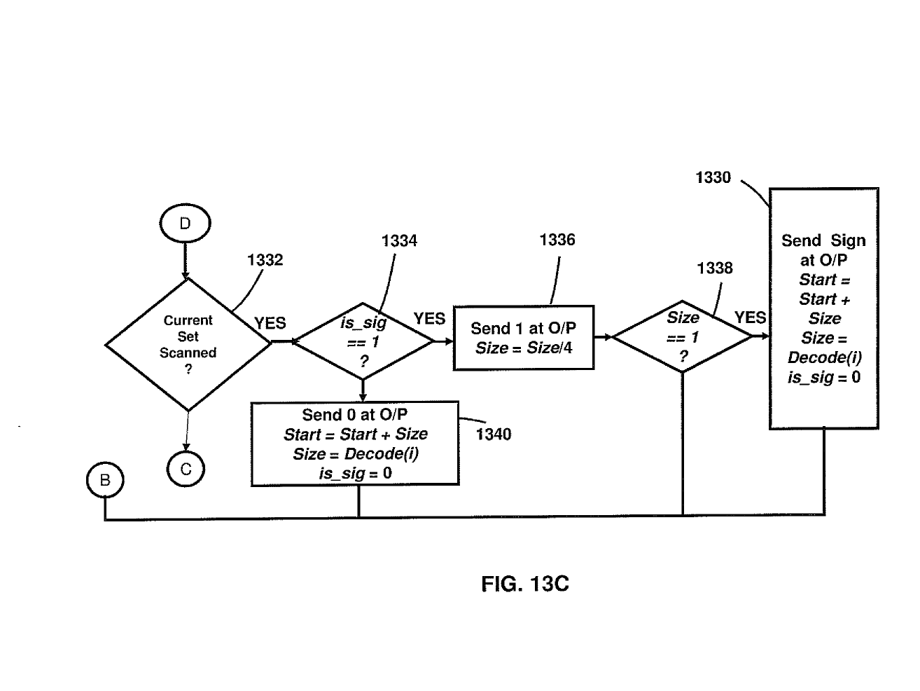

Referring now to FIGS. 13A, 13B and 13C, in accordance with an embodiment, a method 1300 for sequential sorting of refinement pixels is shown. The method 1300 starts encoding data in a sequential order. The method 1300 sets a threshold value and based on the threshold value determines a type of pixel (as the refinement pixel, the significant pixel and the insignificant pixel). If the pixel is a significant pixel, the method 1300 may skip (or bypass) sending the refinement pixel to the output. The method 1300 only sends the sorting bits in the first pass. The method 1300 sends the sorting bits and refinement bits in a sequence. The method 1300 is not dependent on previous passes as described for methods 1000 and 1100.

Referring to FIG. 13A, the method 1300 starts encoding the data at step 1302. Step 1304 checks for a maximum threshold value (a value of most significant bit). The method 1300 sets one or more variables for encoding the data at step 1306; in this embodiment, four variables are set. The four variables comprise start (the value stored in the start register), size (i.e., set size) controllable by the user, i iteration for each pass (from address counter), signal from the pixel tester unit 208. The variables are set as the start (set as 0), the size (set as k), the i (set as 0) and is_sig (set as 0). At step 1308, the method 1300 checks if the one or more pixels in the set have been scanned. If all the pixels have been scanned then the method 1300 sends refinement bits to the output if pixel (i) is greater than or equal to 2T (the threshold value) (step 1310). At step 1312, the method checks if the bit rate has been achieved. If not, then at step 1314, the method checks if the threshold value T=0 and if T=0, then the method 1300 ends the encoding at step 1316. However, if T is not equal zero at step 1314, then the method 1300 proceeds to step 1318 and sets T=T/2 and then repeats from step 1306.

After step 1308, if all the pixels have not been scanned then at step 1320, the method 1300 checks if the bit rate has been achieved, and if yes, encoding is stopped at step 1316. If the bit rate has not been achieved, then the method proceeds to step 1322 (FIG. 13B) and checks if pixel (i)>2T; if yes, at step 1324 the value (i) is incremented and the method proceeds to step 1332 (FIG. 13C); if no, the at step 1326 the method 1300 checks if pixel(i)<T and if yes, goes to step 1324 and if not, then at step 1328, the method 1300 sets is_sig=1 and again increments (i) (step 1324).

Referring to FIG. 13C, the method 1300 performs a routine similar to as method 1100 at FIG. 11C. That is, at step 1332 the method checks if the current set has been scanned. If the current set has not been scanned then the method returns back to step 1322 (FIG. 13B) to once again start checking to identify the refinement pixel and the significant pixel. If the current set has been scanned, the method 1300 checks if is_sig is equal to 1 (step 1334) and if yes, sends 1 to the output while setting set size equal to size/4 (step 1336). Further, in FIG. 13C, after step 1334, if is_sig is not equal to 1, the method 1300 sends 0 to the output and resets the variables (step 1340), then proceeds to step 1308 (FIG. 13A). After step 1336, at step 1338, the method 1300 checks if the size equals 1 and if not, then returns to step 1308 (FIG. 13A), but if yes, then at step 1330, the method 1300 sends the sign to the output, sets start equal to start plus size, and sets size equal to the value decode(i), and sets is_sig equal to zero before returning to step 1308 (FIG. 13A).

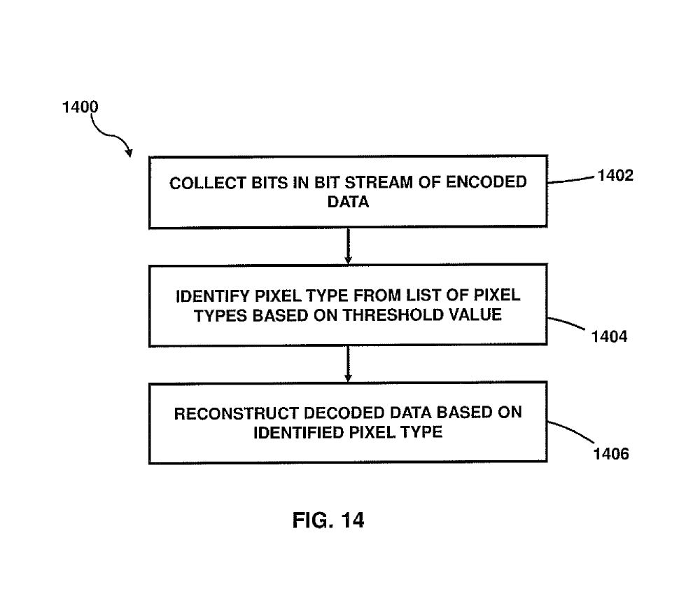

Referring to FIG. 14, a method 1400 for decoding encoded data is shown. In an embodiment, the decoding may be performed by the apparatus 800.

At step 1402, the method 1400 provides collection of a plurality of bits in a bit stream of the encoded data. The encoded data may be received from the entropy encoder 200.

At step 1404, the method 1400 identifies a pixel type from a list of pixel types from the plurality of bits in the encoded data. The pixel type is identified based on a threshold value and may comprise a refinement pixel, a significant pixel and an insignificant pixel. In an embodiment, the pixel type is identified by the pixel tester 806.

At step 1406, the method 1400 reconstructs the encoded data based on the identified pixel type. The decoded image may be either a compressed image or an uncompressed image.

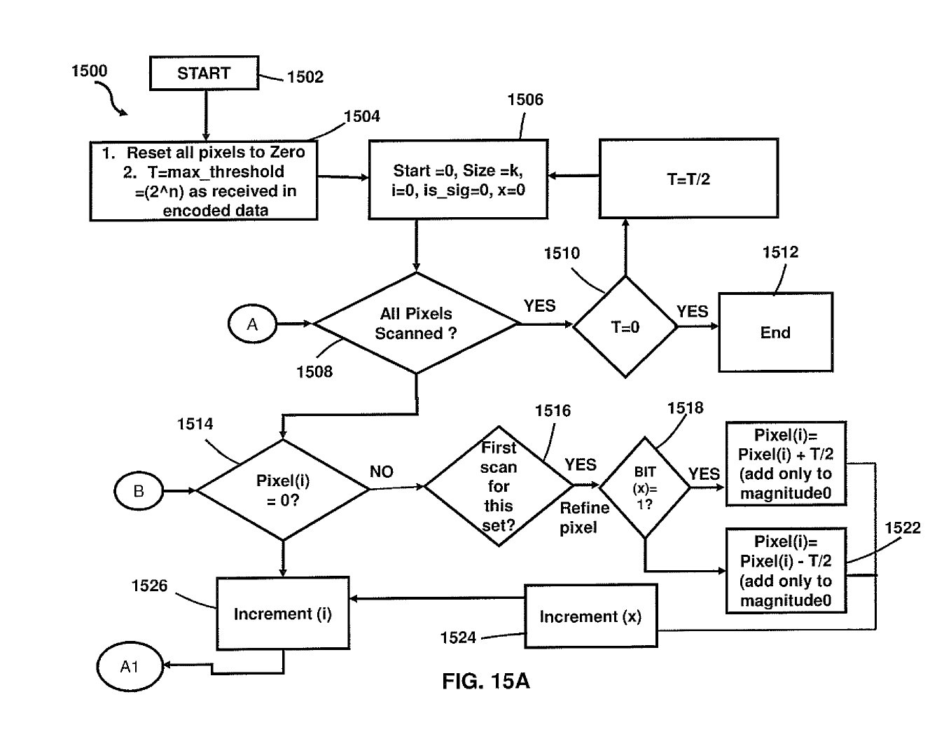

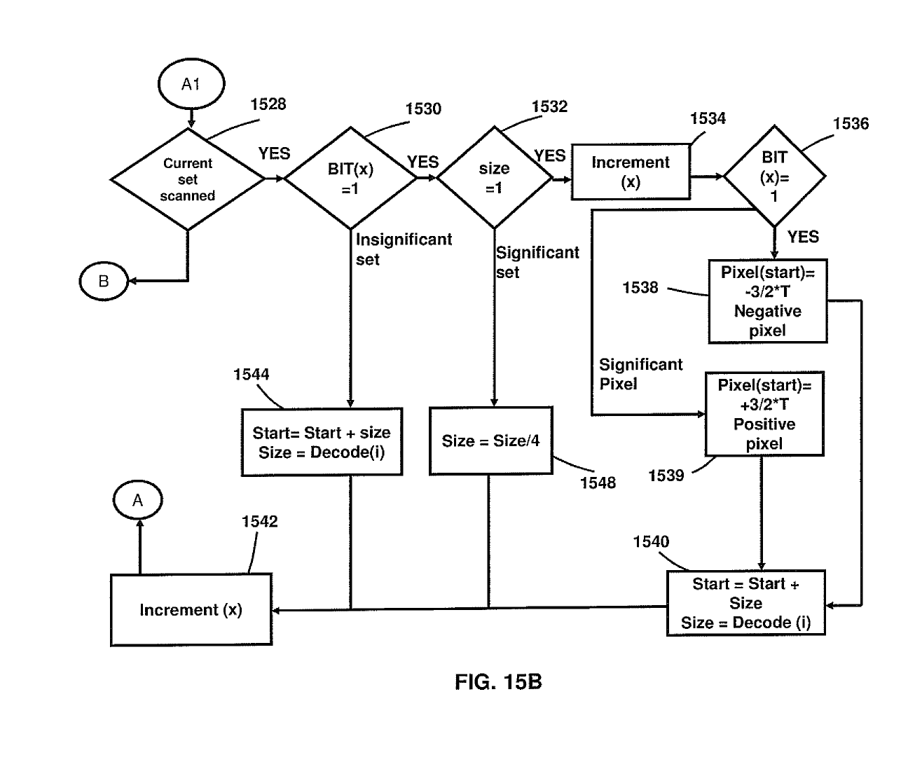

In accordance with an embodiment of the present invention, FIGS. 15A and 15B show a method 1500 of decoding encoded data in which the refinement pass and the sorting pass are merged. The decoding may be performed by the apparatus 800 described above.

In FIG. 15A, at step 1502, the method 1500 starts decoding the data (image data). At step 1504, the method 1500 resets all pixels in an encoded data received from a memory. The method 1500 a threshold value (2ⁿ) in the encoded data. The threshold value is a value of highest significant bit in the bit stream. The method sets all four variables in step 1506. The method 1500 checks if all the pixels are scanned in the image (step 1508). If all the pixels are scanned, then method 1500 checks if T=0 (step 1510). The method 1500 ends decoding for T=0 (step 1512). If T is not equal to 0, the method sets T=T/2 and repeat from step 1506.

After step 1508, the method 1500 checks if pixel (i) is equal to zero. If the pixel (i) is not equal to zero, the method checks if the scan is first scan or not (step 1516). At step 1518, method checks if BIT(x)=1 if the scan is the first scan. At step 1520 and step 1522, the method 1500 defines pixel (i) as pixel (i)+T/2 and pixel (i)−T/2 respectively for the refinement pixel. The T/2 is added and subtracted to magnitude 0. After the pixel is modified ate step 1520 and step 1522, the method 1500 increments (x) and (i) (step 1524 and step 1526 respectively). After step 1514, at step 1526 again, the method increments (i).

Referring to FIG. 15B, after step 1526, the method checks if the current set is scanned (step 1528). The method again goes to step 1514, based on checking of the scanning. If the current set is scanned, the method checks if BIT(x) is equal to one (step 1530). The method 1500 then checks if the set size is equal to 1 (step 1532) and increments (x) (step 1534). The method 1500 checks if BIT(x)=1 (step 1536) and modifies the significant pixel as by adding or subtracting 3T/2 depending upon the sign bit (step 1538 and step 1539). The method 1500 then set the start and size and increments (x) (step 1540 and step 1542). After the step 1542, the method again starts from step 1508. After step 1530, based on checking of BIT(x) equal to 1, the method 1500 sets the start equal to start and size and size equal to decode (i) (step 1544). After step 1532, is the set is significant set, the method 1500 sets the size equal to size/4 (step 1548).

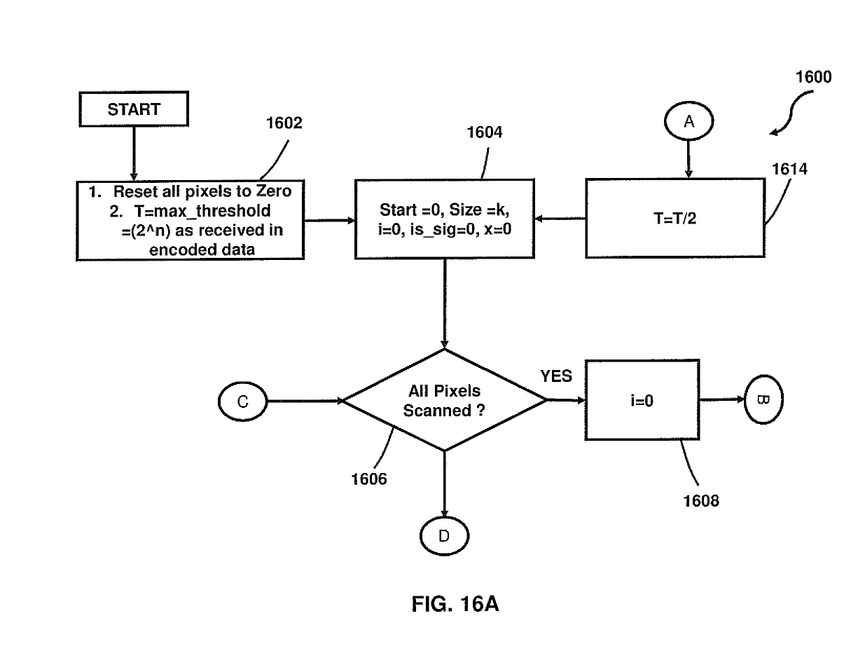

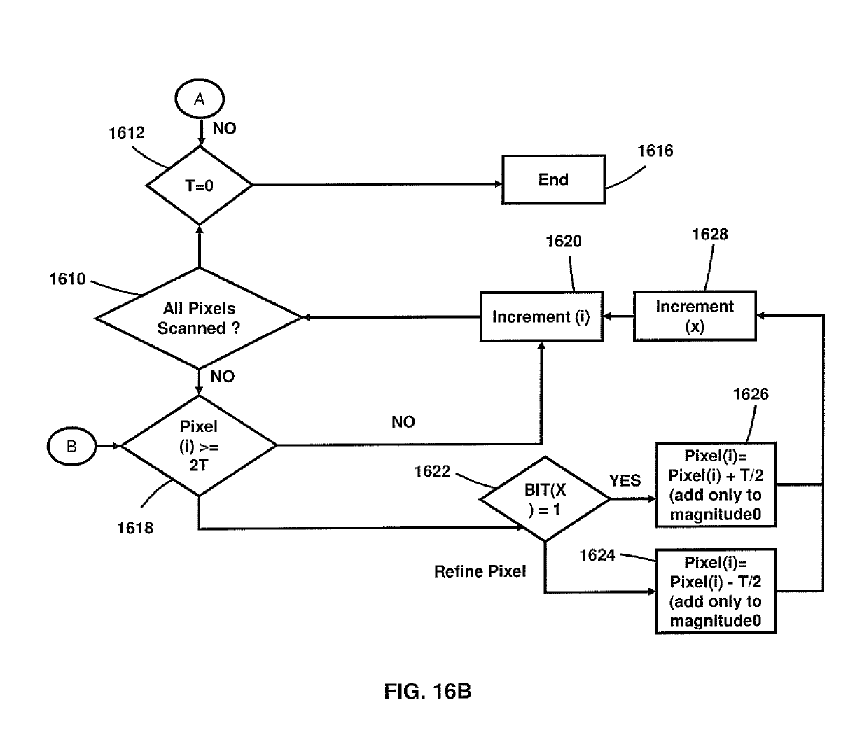

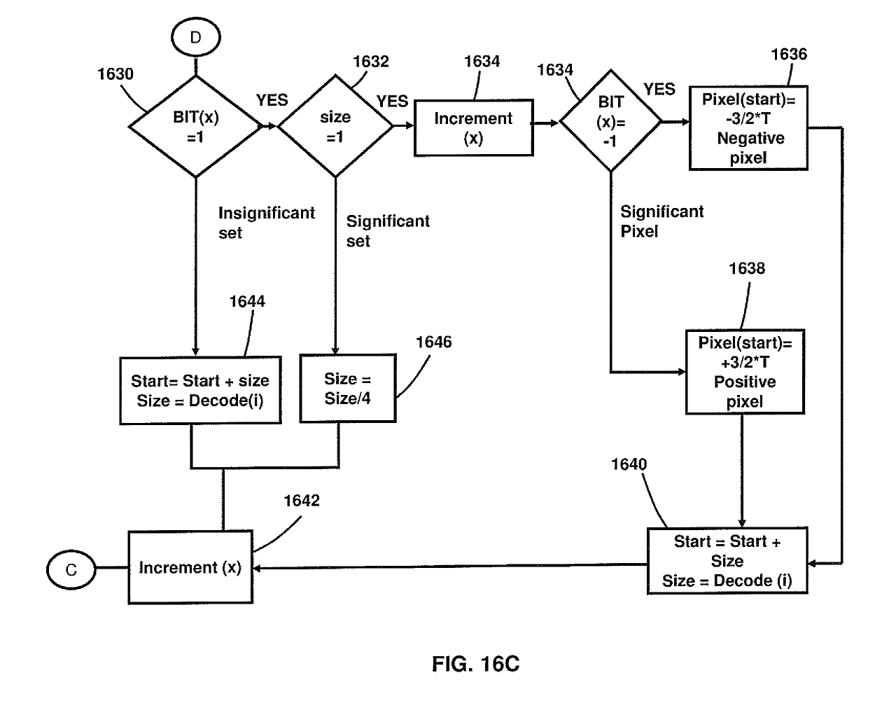

Referring now to FIGS. 16A-16C, in accordance with an embodiment, a method 1600 for decoding data and arranging bits sequentially is shown. The decoding may be performed by the apparatus 800 described above.

Referring to FIG. 16A, at step 1602, the method 1600 starts decoding encoded image data. The method 1600 sets all four variables (as described for method 1500) in step 1604. The method 1600 checks if all the pixels have been scanned in step 1606. Based on this checking, if all of the pixels have been scanned, the method 1600 sets i=0 at step 1608; otherwise the method 1600 proceeds to step 1630 (FIG. 16C).

Now referring to FIG. 16B, at step 1610, the method 1600 checks if all the pixels have been scanned. If all the pixels have been scanned, the method 1600 ends the decoding at step 1616. If all the pixels are not scanned, the method 1600 checks if pixel (i) greater than or equal to 2T at step 1618. If the pixel is not greater than or equal to 2T, the method increments (i) at step 1622 and method goes back to step 1610. If the pixel is greater than or equal to 2T, the method checks if BIT(x) is equal to 1 at step 1622. For refinement pixel, the method adds or subtracts T/2 to pixel (i) at step 1624 and 1626 for modifying the pixel value. After modification, the method 1600 increments (x) in step 1628 and goes back to step 1620. At step 1612, the method 1600 checks for T=0 and at step 1614, the method 1600 sets T=T/2 and starts from step 1604.

Referring to FIG. 16C, after step 1606 in FIG. 16(a), the method 1600 checks if BIT(x)=1 at step 1630. The method 1600 then checks if the set size is equal to 1 at step 1632. If the set size is 1, the method 1600 increments (x) at step 1634. The method 1600 then checks if BIT(x) is equal to negative 1 at step 1634. Based on the check in step 1630, the method 1600 adds negative 3T/2 to the negative pixel at step 1636 and adds +3T/2 to pixel (start) for positive pixel for the significant pixel at step 1638. The method 1600 then sets the start value and start value (at step 1640) and increments the (x) at step 1642. The method then goes back to step 1606. After step 1630, for the insignificant set, the method sets the start and size at step 1644 and again goes to step 1642. After step 1632, for the significant set, the method 1600 sets the set size equal to size/4 and the method 1600 again goes back to step 1642.

The methods 1000, 1100, 1300, 1400, 1500 and 1600 may be performed via software, which as is understood by those of skill in the art, comprises computer executable instructions. Generally, computer executable instructions may include routines, programs, objects, components, data structures, procedures, modules, functions, etc., for performing particular functions or implementing particular abstract data types. The methods 800, 900, 1100, and 1200 may also be practiced in a distributed computing environment where functions are performed by remote processing devices that are linked through a communications network. In a distributed computing environment, computer executable instructions may be located in both local and remote computer storage media, including memory storage devices.

The order in which the methods 1000, 1100, 1300, 1400, 1500 and 1600 are described is not intended to be construed as a limitation, and any number of the described method blocks or steps can be combined in any order to implement the methods 1000, 1100, 1300, 1400, 1500, and 1600 or alternate methods. Additionally, individual blocks or steps may be deleted from the methods 1000, 1100, 1300, 1400, 1500, and 1600 without departing from the spirit and scope of the subject matter described herein. Furthermore, the methods 1000, 1100, 1300, 1400, 1500, and 1600 may be implemented in any suitable hardware, software, firmware, or combinations thereof. However, for ease of explanation, in the embodiments described, the methods 1000, 1200, and 1300 may be considered to be implemented in the encoding apparatus 200 and the methods 1400, 1500 and 1600 may be considered to be implemented in the decoding apparatus 800.

The description of the specific embodiments described reveals the general nature of the embodiments herein such that those of skill in the art, by applying current knowledge, can readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method for encoding data using a wavelet based entropy encoder, the method comprising:
partitioning the data, by a set partitioning unit, into a plurality of sets;
obtaining, by an address control and generation unit (ACGU), a set size of the plurality of sets based on a transformed memory address of one or more pixels in the plurality of sets;
scanning, by a pixel tester unit, in accordance with the set size, the plurality of sets in a single pass, wherein the single pass comprises a plurality of scanning passes;
identifying, by the pixel tester unit, a type of the one or more pixels from a list of pixel type based on a threshold value generated by the single pass; and
generating in the single pass, by a main core control unit, a bit stream, wherein the bit stream comprises encoded data, and wherein the encoded data includes at least one of a significant bit and a refinement bit.

2. The method of claim 1, wherein the set size is used to decode a next address for the one or more pixels.

3. The method of claim 1, wherein the transformed memory address is obtained by applying a linear indexing on the one or more pixels.

4. The method of claim 1, wherein the list of pixel type comprises at least one of a refinement pixel, a significant pixel and an insignificant pixel.

5. The method of claim 1, wherein the scanning passes comprise a refinement pass and a sorting pass.

6. The method of claim 1, wherein the threshold value includes a value of a highest significant bit in the one or more pixels in the plurality of sets.

7. The method of claim 1, wherein the significant bit and the refinement bit in the bit stream are arranged in one of a random order and a sequential order.

8. An apparatus for encoding image data, the apparatus comprising:
an address control and generation unit (ACGU) for obtaining a set size based on a transformed memory address of a plurality of pixels in a plurality of sets associated with the image data, wherein the set size is used to decode a next address for the plurality of pixels;
a pixel tester unit coupled to the ACGU that (i) scans, in accordance with the set size, the plurality of sets in a single pass, wherein the single pass includes one or more scanning passes, and (ii) identifies a type of the plurality of pixels from a list of pixel types based on a threshold value; and
a main control core unit, coupled to the ACGU and the pixel tester unit, for generating a bit stream of encoded image data in the single pass, wherein the encoded image data has at least one of a significant bit and a refinement bit.

9. The apparatus of claim 8, wherein the ACGU comprises:
a priority encoder having one or more shift registers for obtaining a linear address of the plurality of pixels; and
a linear address to memory address converter for transforming the linear address into the transformed memory address.

10. The apparatus of claim 8, wherein the pixel tester unit comprises:
a check refinement block for checking for a refinement pixel from the list of pixel types based on the threshold value;
a check significant block for checking for a significant pixel from the list of pixel types based on the threshold value; and
a bit generator for generating an encoded bit stream output signal in accordance with the refinement bit, the significant bit and an insignificant bit.

11. The apparatus of claim 8, further comprising a bit rate control unit for controlling a rate of the generated bit stream.

12. The apparatus of claim 8, further comprising a stream buffer unit for starting and stopping generation of the bit stream.

13. The apparatus of claim 8, wherein the ACGU and the main control core unit collectively form a set partitioning unit that partitions the image data into the plurality of sets.

14. The apparatus of claim 8, wherein the list of pixel types comprises at least one of a refinement pixel, a significant pixel, and an insignificant pixel.

15. The apparatus of claim 8, wherein the one or more scanning passes in the single pass comprises a refinement pass and a sorting pass.

16. The apparatus of claim 8, wherein the threshold value includes a value of a highest significant bit in the plurality of pixels in the set.

17. The apparatus of claim 8, wherein the significant bit and the refinement bit in the bit stream are arranged in at least one of a random order and a sequential order.

18. An apparatus for decoding encoded data provided as a bit stream comprising a plurality of bits, the apparatus comprising:
a pixel tester unit for identifying, in the plurality of bits, a pixel type from a list of pixel type based on a threshold value; and
a data generator unit for generating decoded data based on the identified pixel type.
